(19) United States
(12) Patent Application Publication
(10) Pub. No.: US 2025/0306889 A1
(43) Pub. Date: Oct. 2, 2025

(54) SYSTEMS AND METHODS FOR TOOL SYSTEM MEASUREMENT AGGREGATION AND CONTROL USING ELECTRONIC AND FIRMWARE MAPPINGS

(71) Applicant: Schlumberger Technology Corporation, Sugar Land, TX (US)

(72) Inventors: Jianwen Wang, Katy, TX (US); Nikolay Baklanov, Sugar Land, TX (US); John Lee, Sugar Land, TX (US); Yang Hu, Sugar Land, TX (US); Shreyas Rajendra Poyrekar, Houston, TX (US); Xuedong Yang, Sugar Land, TX (US); Maxim Klyuzhev, Sugar Land, TX (US); Yifang Yang, Sugar Land, TX (US)

(21) Appl. No.: 18/621,959

(22) Filed: Mar. 29, 2024

(51) Int. Cl. G06F 8/65

(52) U.S. Cl. CPC G06F 8/65

(57) ABSTRACT

A method may include receiving an indication of an electromechanical tool system including two or more tool components, where each tool component is configured to perform a respective service, retrieving electronic information for the two or more tool components based on the indication, retrieving firmware information for the two or more tool components based on the indication, generating a service definition file based on the electronic information and the firmware information, where the service definition file indicates a plurality of services capable of being performed by the two or more tool components, and outputting the service definition file to control operation of the electromechanical tool system.

### BACKGROUND OF THE INVENTION

The present disclosure relates generally to downhole tools and more specifically to techniques for controlling downhole tools and acquiring measurements (e.g., measurement aggregation from multiple downhole tools).

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological formation is a remarkably complex endeavor. During certain operations, such as well production operations, it may be necessary to provide a wireline including a specific composition of tools to perform a specific function. As such, various downhole tools may be used interchangeably with various operating parameters to achieve a desired function related to the well production operation. However, at least in some instances, when creating a new composition of tools with new operating parameters to perform a new function, it may be difficult to create instructions to enable a software system and a downhole firmware system to perform the function. Furthermore, it may be difficult to create a common instructional file for both the software system and the downhole firmware system to use.

### SUMMARY OF THE INVENTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a method includes receiving an indication of an electromechanical tool system including two or more tool components, where each tool component is configured to perform a respective service, retrieving electronic information for the two or more tool components based on the indication, retrieving firmware information for the two or more tool components based on the indication, generating a service definition file based on the electronic information and the firmware information, where the service definition file indicates a plurality of services capable of being performed by the two or more tool components, and outputting the service definition file to control operation of the electromechanical tool system.

In certain embodiments, a method includes receiving an indication of an electromechanical tool system including two or more tool components, where each tool component is configured to perform a respective function, retrieving reference tool component information corresponding to the two or more tool components based on the indication, generating a service definition file based on the reference tool component information, where the service definition file indicates a plurality of services capable of being performed by the two or more tool components. The method further includes providing the service definition file to a software system and a downhole firmware system in parallel, receiving an electromechanical interface output as an output from the software system, and controlling operation of the electromechanical tool based on the electromechanical interface output.

In certain embodiments a non-transitory computer-readable medium comprising computer-executable instructions that, when executed, cause a processor to receive an indication of an electromechanical tool system comprising two or more tool components, where each tool component performs a respective function and wherein at least one tool component of the two or more tool components comprises one or more devices. Further, the computer-executable instructions that, when executed, cause a processor to retrieve a reference tool component information from a library corresponding to the two or more tool components based on the indication, where the library comprises a plurality of reference tool component information corresponding to a plurality of tool components, generate a service definition file based on the reference tool component information, wherein the service definition file indicates a plurality of services capable of being performed by the two or more tool components, provide the service definition file to a software system and a downhole firmware system in parallel, receive an electromechanical interface output as an output from the software system and the downhole firmware system, and control operation of the electromechanical tool system based on the electromechanical interface output.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a partial cross-sectional view of an example of a downhole tool having one or more downhole tools that are suspended into a subsurface formation, in accordance with an aspect of the present disclosure;

FIG. 2 is flow chart for the generation of a service definition file, in accordance with an aspect of the present disclosure;

FIG. 3 illustrates an example portion of an SDF, in accordance with an aspect of the present disclosure;

FIG. 4 illustrates a flow chart of a method for using an SDF to determine various service components and to generate a user interface, in accordance with an aspect of the present disclosure;

FIG. 5 shows a user interface, such as the one generated in FIG. 4, in accordance with an aspect of the present disclosure;

FIG. 6 illustrates a method for creating and using a SDF in both a software system and a downhole firmware system, in accordance with an aspect of the present disclosure; and

FIG. 7 illustrates a process for creating an SDF using service components, and further commercializing a service, in accordance with an aspect of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As generally discussed above, it may be desirable to assemble, build, or generate tool systems that use combinations of different tools, or even plan to develop (e.g., draft schematics) the tool systems, to perform various hydrocarbon production services. The hydrocarbon product services may include intervention services (e.g., milling through scale in pipes, removing debris from a wellbore, performing shifting operations, tube cutting, and so on) and/or conveyance operations (e.g., translating along (e.g., a path towards the surface or away from the surface) a wellbore using a tractor.) In any case, each tool may utilize multiple devices (e.g., boards, drives, sensors, actuators, and so on) to perform their one or more associated services. In general, the devices may control the tools within a tool system (e.g., via communication to the boards of the tools), via communication protocols (e.g., controller area network (“CAN”) protocols or otherwise). Further, each tool system may utilize multiple tools that can operate in a concerted manner or otherwise cooperatively (e.g., two or more tools may operate to perform a particular service) as well as having overlapping devices. As such, it may be difficult to develop software and/or firmware to coordinate the operation of the different tools of the tool system.

The present disclosure is directed to techniques for improving the efficiency of controlling tool systems and acquiring measurements with the tool systems. As referred to herein, a “tool system” is a system that include multiple tools, by generating and/or utilizing a service definition file (“SDF”) (e.g., universal tool file (“UTF”), service configuration file (“SCF”)). In general, the SDF indicates relationships between tools, devices of the tools, software systems, and services capable of being performed by the tools. As described in further detail herein, the SDF may facilitate communication between surface acquisition/control software (e.g., a surface software system) and downhole tools (e.g., a downhole firmware system), including collecting measurement/status from the downhole tools of the tool system, as well as sending control commands or invoking downhole automated control sequences from the surface. In some embodiments, the SDF may include instructions for generating a user interface (e.g., a graphical user interface (“GUI”)) using reference information (e.g., electronic specifications, hardware information, firmware information, or a combination thereof) indicating reference information associated with the tools of the tool system and the devices (e.g., PCBs, sensors, actuators) used by the tools. For example, the SDF may include components mappings (e.g., operational relationships) for a tool system. In any case, the SDF may be used to generate both firmware and software for the tool system. For example, the SDF may be fed into modules for software and firmware development in parallel. In this way, modules for generating software (e.g., a surface software system) and firmware (e.g., a downhole firmware system) may independently adapt their configurations to create a synergistic functionality and communication (e.g., telemetry) schema that extends beyond their individual capabilities. In particular, the synergistic functionality based on the disclosed techniques includes interplay of physical operations of the electromechanical tools and corresponding data processing tasks (e.g., and other tasks performed by tool systems).

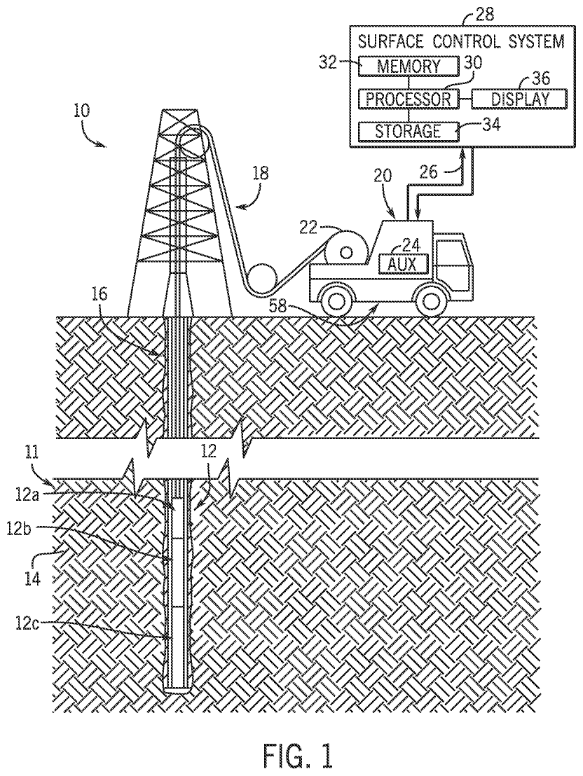

With the foregoing in mind, FIG. 1 illustrates a tool system 10 (e.g., wireline, wireline service, combination of tools, wireline conveyance, logging system, intervention system, etc.) that may employ the systems and methods of this disclosure. The tool system 10 may be used to convey tools 12, through a geological formation 14 via a borehole 16. Any suitable number of tools may be used, and the tool system 10 is not limited to tools 12a, 12b, and 12c (e.g., collectively tools 12). In the example of FIG. 1, a downhole device 11 having tools 12 is conveyed on a cable 18 via a logging winch system (e.g., vehicle 20). Although the vehicle 20 is schematically shown in FIG. 1 as a mobile logging winch system carried by a truck, the vehicle 20 may be substantially fixed (e.g., a long-term installation that is substantially permanent or modular). In some embodiments, the tool system 10 may be used in an offshore unit (e.g., Independent-Leg Self-Elevating unit, Mat-Supported Self-Elevating, Column-Stabilized, Drillship, etc.). Any suitable cable 18 for well logging may be used. The cable 18 may be spooled and unspooled on a drum 22 and an auxiliary power source 24 may provide energy to the vehicle 20 and/or the tools 12.

In general, the tools 12a, 12b, and 12c are electrically coupled to receive a voltage supplied from the surface and/or a downhole power cartridge. For example, tools 12a, 12b, and 12c may correspond to power cartridges, hydraulic modules, rotary compensators, rotary power, bailers and the like. In some embodiments, the tools 12a, 12b, and 12c may be communicatively coupled to a surface control system 28 (e.g., software system, cloud-based software system, edge-based system.) For example, data signals 26 (e.g., uplink, downlink) may be transmitted from the surface control system 28 to one or more of the tools 12a, 12b, and 12c, and the data signals may be related to the sensor data, operating conditions data, operating parameters data, or any other desired data that may be returned to the surface control system 28 from the tools 12a, 12b, 12c. Additionally, the data signals 26 may include control signals, such as commands. The surface control system 28 may be any electronic data processing system that can be used to carry out the systems and methods of this disclosure. For example, the surface control system 28 may include a processor 30, which may execute instructions stored in memory 32 and/or storage 34. As such, the memory 32 and/or the storage 34 of the surface control system 28 may be any suitable article of manufacture that can store the instructions. The memory 32 and/or the storage 34 may be read-only memory (“ROM”), random-access memory (“RAM”), flash memory, an optical storage medium, or a hard disk drive, to name a few examples. A display 36, which may be any suitable electronic display, may display images generated by the processor 30. The surface control system 28 may be a local component of the vehicle 20 (e.g., within the tool system 10), a remote device that analyzes data from other vehicles 20, a device located proximate to the wireline operation, or any combination thereof. In some embodiments, the surface control system 28 may be a mobile computing device (e.g., tablet, smart phone, or laptop), a server remote from the vehicle 20, and/or an edge server mounted on the vehicle. As shown in the illustrated embodiment, the surface control system 28 also includes a power supply 58 that is may be used to provide power to the tools 12a, 12b, 12c via the cable 18.

As described above, the tool system 10 may have any number or type of tools, and is not limited to the illustrated three tools (e.g., the tool 12a, the tool 12b, and the tool 12b. In certain implements of the tool system 10, a tool 12a, 12b, and/or 12c may include a power cartridge, capable of providing power, motor control and/or logical control to other tools and/or components of the tool system 10. In some embodiments, the tool 12a, 12b and/or 12c may include sensors for formation and/or production measurements, a tractor for conveyance, or include mechanical mechanisms to operate completion control elements, such as sliding sleeves, safety valves, and the like. Notably, tools may be added, removed, and/or arranged in various ways to generate a desired service (e.g., function of the tool system 10). For example, one or more tools 12a, 12b, 12c may arranged to perform a downhole tractor service, downhole slot cutting service, downhole shifting service, downhole milling service, downhole scale removal service, downhole debris removal service, downhole plug setting service, downhole tubing cutter service, downhole chemical jetting service, or the like.

One or more tools 12a, 12b, 12c of a tool system 10 may include printed circuit boards (e.g., “PCBs”) that are adapted to perform one or more tasks. For example, one or more PCBs may be a primary PCBs which include processing functions (e.g., digital signal processing “DSP”), a microcontroller unit (e.g., “MCU”) and respective firmware for a respective tool 12a, 12b, 12c or a respective group of tools. That is, a primary PCB may perform functions for more than one tool 12a, 12b, 12c. Further, tool 12a, 12b, 12c may include secondary PCBs without processing functions or controlling functions and without firmware. One or more primary PCBs may function as a communication node (e.g., downhole communication node, hub server, proxy server) where the primary PCBs may communicate directly with the surface control system 28 (e.g. software system.) The primary PCB may also act as a data aggregator for the secondary PCBs, relaying data to the software system. In some embodiments, the primary PCB may also distribute commands (e.g., command mappings) downlinked from the surface control system 28.

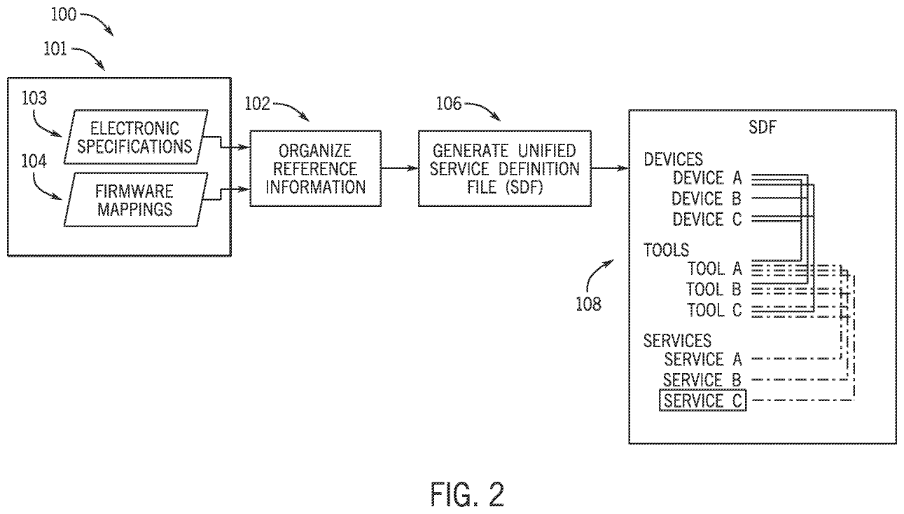

As discussed above, a service definition file (“SDF”) indicates relationships (e.g., electrical relationships, protocol relationships) between tools, devices (e.g., PCBs, actuators, sensors) of the tools, software systems, and services capable of being performed by the tools. In some embodiments, the SDF includes data that indicates a multi-level organization of the tool system 10 that facilitates controlling new tool systems and measurement aggregation (e.g., aggregation of measurements as determined by a tool). For example, the SDF may include a multi-level organization of tools, devices, and services capable of being performed by a tool system 10. The multi-level organization may aid a process of initiating a processor developing both software (e.g., used to create graphical user interface) and firmware used for control of the tool system. With this in mind, FIG. 2 shows an example of a process 100 for generating a SDF 108. In general, the steps of the process 100 may be performed by any suitable processor, such as the processor 30 of the tool system 10. In other embodiments, the steps may be performed by a processor 30 of an independent computer (e.g., CAD computer, instrumental computer) external or separate from the tool system 10, capable of creating and transferring the SDF to the surface control system 28 via one or more suitable means or communication (e.g., internet). Although the discussion below is described with respect to the processor 30, it should be noted that this is meant to be non-limiting and any other suitable processor, or one or more processors, may be perform the process 100. In some embodiments, the SDF may be created or generated at least partially by artificial intelligence (e.g., A.I.) In other embodiments, the SDF may be created or generated at least partially by a human user.

At block 102, the processor 30 organizes reference information 101 for a tool system 10. In general, the reference information 101 (e.g., reference component information) may include electronic specifications 103 (e.g., electronic information) and firmware information 104 corresponding to the tools of a new tool system 10. In some embodiments, the processor 30 may perform block 102 after receiving a request (e.g., submitted by a user) to create software and firmware for the new tool system. In general, the electronic mappings are data indicating how the PCBs, sensors, and/or actuators are related and connected to a particular tool. In some embodiments, the request may indicate an identity of the tool components of the tool system, services capable of being performed by the respective tools, devices and/or commands associated with the tools, or a combination thereof.

In some embodiments, the processor 30 may receive firmware information 104 which may be used to define tools 12 combined in a desired service. In this context, the tools 12 may be the same as tools 12a, 12b, and/or 12c in FIG. 1. For example, firmware information 104 may include specification details related to process controllers (e.g., PID controllers), logic controllers (e.g., state machine controllers). Specifically, firmware information 104 may include sensor sensitivity ranges, measurement ranges, acquisition circuit conversion factors, tool module elements, and the like. In some embodiments, the firmware information 104 may be accessed through electronic data sheets (“EDS”) of the one or more tools used in the desired service. In this context, an EDS may include a specification table for PCBs of tools, defining inputs, outputs, process variables, configurable properties of controllers, etc.

At block 106, the processor 30 generates the SDF 108 using the organized reference information 101 (e.g., components library, controller dictionary, communication dictionary). In general, generating the SDF 108 may include assembling code for a software file or a user interface (e.g., a GUI) that enables control of the tool system 10. In some embodiments, generating the processor 30 may generate the SDF 108 by creating code that is specific to the tool system. In some embodiments, the processor 30 may provide information to a user that aids the user to generate the code, such as indicating the tool components, services, and devices associated with the tool system corresponding to the request. That is, at least in some instances, block 106 may be at least partially performed based on user input (e.g., software code) and the processor 30 receives the user input. In some embodiments, the processor 30 may generate the SDF using artificial intelligence to assemble code for the tool system 10.

In some embodiments, the SDF 108 may be presented in a human-readable format within a text file. For example, the SDF 108 may include code written in a programming language, such as C, C+, python, and so on. At least in some instances, the SDF 108 may be further secured (e.g., during the deployment process) against unauthorized modifications by embedding a unique auto-generated identifier into the file so the firmware system and software system can do cross-checks and validations.

In some embodiments, the SDF 108 may include or indicate operational parameters, such as sensor and actuator operational parameters, including but not limited to sensitivity, measurement, and control ranges. Additionally or alternatively, the SDF 108 may indicate circuit conversion factors for data interpretation and translation to the real-world values. Further, the SDF 108 may indicate tool module elements (e.g. downhole mechanical sondes) and boundary for their instances (e.g. min/max number of mechanical sections of a particular type), actuator and sensor mappings to the hardware input-output space, the said hardware space mapping to a pool of software variables (e.g. data channels and commands), process controller mappings to the circuit boards, and circuit board mappings to the tool modules. In any case, the components of the SDF 108 (e.g., operational parameters, tool module elements, and the like) may be provided to a user via a GUI to aid a user in determining control adjustments to make to the tools 12 of the tool system 10.

In some embodiments, the SDF 108 includes instructions to generate user interfaces (UI) based on predefined specifications and/or to facilitate dynamic creation of UI elements mapped to service's requirements. For example, a processor 30 may utilize the SDF 108 to establish mappings between downlink telemetry commands, uplink data channels, and corresponding graphical library components (e.g., reference tool components library.) In this way, the SDF 108 may provide an automated, or semi-automated, generation of a presentation layer with linkage to telemetry specs. As referred to herein, the “presentation layer” may be a visual representation of mappings of the tools 12 of the tool system 10.

As one non-limiting example of the disclosed techniques, a user may submit a request or query for a software application or GUI that provides control of a new tool system 10. The processor 30 may receive the request and, in turn, the processor 30 accesses, retrieves, or otherwise obtains reference tool information. In general, the processor 30 may identify each tool 12a, 12b, 12c of the tool system 10, and identify electronic specifications 103 (e.g., identify electronic specifications from each tool 12a, 12b, 12c itself and/or identify electronic specifications using vendor supplied information (e.g., text files)) and/or firmware information 104 corresponding to each tool 12a. 12b. 12c of the tool system 10. Based on the devices and tools 12 identified for the tool system 10, the processor may determine a multi-level organization arrangement for the devices, tools 12, controllers and services capable of being performed by the tools 12. For example, a first level (e.g., first subset) of the multi-level organization may list the devices (e.g., boards, drives, sensors, actuators and so on) associated with a tool system. A second level (e.g., second subset) of the multi-level organization may list the tools and their respective devices, as well indicating overlaps of devices for each tool. A third level (e.g., third subset) of the multi-level organization may list the services capable of being performed by the tools (e.g., combinations of the tools, commands for the tools to perform the service (e.g., commands data), communication protocols for facilitating communication between the tools (e.g., communications protocols data), and so on), as well as indicating overlaps of the tools and devices for each service.

The SDF 108 includes components mapping (e.g., operational relationships) derived from electronic specifications and serves as a basis for the adaptive configuration for both firmware and software as described herein. As referred to herein, “components mapping” refers to electronic mappings, firmware mappings, user interface mappings, command mappings, measurement mappings, and/or service mappings. As referred to herein “electronics mappings” refer to relationships between devices (e.g., PCBs, sensors, actuators) and tools 12, which are used to implement control of the tool system 10 via the software and/or aggregate measurements from the devices. As referred to herein, “firmware mappings” refer to relationships between devices and tools 12, which are used to implement control of the tool system 10 via the firmware. The firmware mappings may include commands (e.g., high-level commands, low-level commands) corresponding to respective firmware for the one or more tools. For instance, the processor 30, may identify a command in the firmware information 104 be implemented in the SDF 108 denoted as “start motor”. As such, the processor 30 may map the command to a specific motor or motors of the one or more tools within the firmware. Each command or groups of commands mapped to the firmware of the one or more tools through the SDF 108 may be organized into respective services within the SDF 108. In some embodiments, the firmware mapping may also be accessed through the electronic data sheets of the one or more tools used in the desired service.

In the illustrated embodiment, the mappings (e.g., relationships) between the service and the respective tool(s) are portrayed by the dotted lines. Further, the solid lines indicate the mapping relationships between the device(s) and tool(s). It should be noted that the illustrated lines are not limiting, and more or less mappings may be present in the SDF 108, including, but not limited to, controllers, communication protocols, and/or components of a user interface. Further, the mappings may be between the devices, controllers, tools, services, user interface or any combination therein, and are not intended to be limited to the illustrated two-way mappings (e.g., tools to devices, tools to services.) Accordingly, the SDF 108 may indicate a hierarchical relationship (e.g., hierarchical structure) between tools, services, and devices. As referred to here, the “hierarchical relationship” indicates services capable of being performed by a tool system, the tool components capable of performing the respective services, and the devices used by the respective tool components.

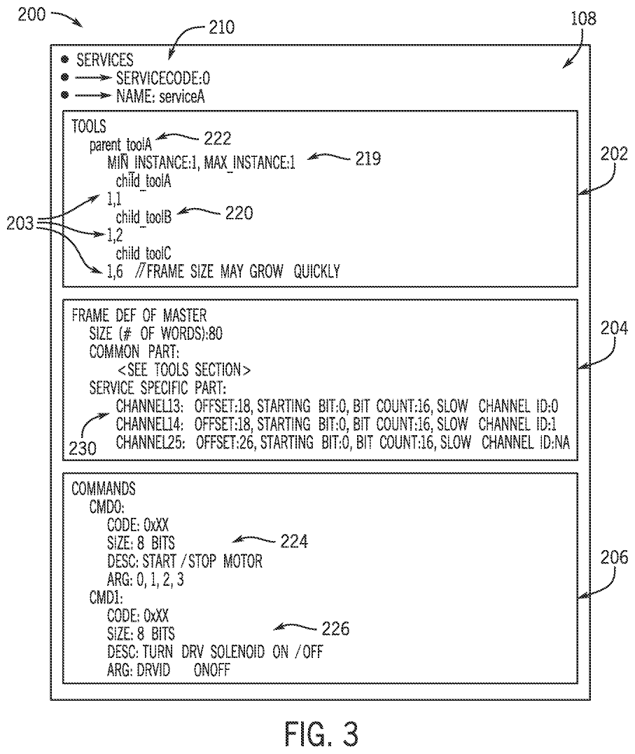

To further illustrate organizational aspects of the SDF 108, FIG. 3 illustrates a window 200 displaying software code corresponding to the SDF 108. As illustrated, the window 200 defines a service 210 including multiple tools 219 denoted in a tool section 202, a communication section 204, and a command section 206. It should be noted that the SDF 108 may include multiple services with different combination of tools (not limited to the one or more tools 219 illustrated), different parameters for the one or more tools 219, alternate commands (e.g., alternate commands data), and/or alternate communications protocols (e.g., alternate communication protocols data). In the illustrated embodiment, the service 210, denoted as “serviceA”, may include tools 219, commands 224, 226, and/or communications protocols 230 related to a cutting function of a wireline (e.g., tool system) for an oilfield operation.

Tool section 202 may define, or otherwise denote one or more tools 219 (e.g., parent tool 222 and child tool(s) 220) that may be used within the service 210, for example, “serviceA”. In the illustrated embodiment, the SDF 108 may define child tool 220 denoted as “child_toolA,” “child_toolB,” or “child_toolC,” which may correspond to a hydraulic module, a compensator, or a section, respectively. The SDF 108 may further define the parent tool 222 denoted as “parent_toolA,” which may correspond to a power cartridge or other energy generating, energy distributing, or controlling tool. As shown in the window 200, the parent tool 222 may encompass or is otherwise organized above the child tool(s) 220. In some embodiments, the one or more tools 219 denoted in FIG. 3 may be the same tools as referred to above (e.g., tools 12a, 12b, 12c). Although one parent tool 222 (e.g., “parent_toolA”) is shown in the illustrated embodiment, it should be noted that any number (e.g., 1, 2, 3, 4, 5, or more) of parent tools 222 may be included in a service, such as service 210. Window 200 may also recognize a maximum tool quantity 203 of each parent tool 222 or each respective child tool 220 associated with a parent tool 222 in a respective service 210. For example, “parent_toolA” may include a maximum of six separate child tools 220 under the command or otherwise controlled by the parent tool 222.

Communication section 204 may define code relating to communication functions between the parent tool(s) 222, child tool(s) 220 and/or a software system, for example the surface control system 28. In some embodiments, the communication section 204 may include code that may be utilized to generate a communication mapping between devices and the one or more tools 219. For example, the communication section 204 may indicate telemetry frame size, frame slots to channel map, and frame definitions for the one or more tools 219. For instance, the communication section may define specific channels (e.g., range of bits) that may correspond to the child tool(s) 220 and/or the parent tool 222. In some embodiments, the parent tool 222 may act as a data aggregator, and will aggregate data received from the child tool(s) 220 to be further communicated with the software system. As such, in some embodiments, only the parent tool 222 may be adapted to communicate directly with the software system. Accordingly, the communication section 204 may define protocols to allow for data collection and aggregation in the parent tool 222, to be further communicated with the software system via, for example, CAN or a CAN variation.

Command section 206 (or a section defining the controller mappings) may define code (e.g., overlaid code structure) relating to command functions between the parent tool 222, child tool(s) 220 and/or the software system, for example the surface control system 28. In some embodiments, the command section 206 may include code related to the commands sent from the software system to the parent tool 222, which may then distribute the commands to child tool(s) 220 to perform command specific functions. It should be noted that the SDF 108 may include command code for every tool of the one or more tools 219 that may receive a command. In the illustrated example, the commands 224, 226 may be commands directed towards either the parent tool 222, or the child tool(s) 220. For example, command 224, described as “Start/stop motor,” may be directed to the child tool 220 comprising a motorized drill bit. In this example, if a condition is met, the child tool 220, including the motorized drill bit, may start (e.g., operate in an on configuration) and may continue to run (e.g., operate) until a further condition is met.

As will be appreciated, a user may be able to generate a new service and/or modify the service 210 without “hardcoding” an entirely new software file for each new tool system. That is, the user may generate the new service and/or modify the service 210 without extensive change to the firmware of tools 219 and with minimal or no change to the software system. In this context, hardcoding is meant as any coding of service components, tool definitions (e.g., tool component definitions), communication protocols (e.g., uplink telemetry commands (e.g., command handlers) and so forth, that utilize a high level of software experience and/or an extended amount of time to complete (i.e., 1 week, 2 weeks, 1 month, 6 months, 1 year.) In the present embodiments, the user may be able to generate a new service and/or modify the service 210 by configuring preexisting service components (e.g., commands 224, 226 (e.g., commands data), communication protocols 230 (e.g., communications protocols data), one or more tools 219 (e.g., tool component definitions) of the SDF 108 into a new tool orientation that may perform one or more new functions. For example, a new service may include a parent tool and one or more child tools that have already been implemented into the SDF 108 from prior generated services, such as service 210. In this way, the user may “build” a service 210 without needing to code complex architecture related to new tools, new commands, and/or new communication protocols. As such, new services may be created in an expedited way to decrease implementation from a theoretical stage to field utilization and commercialization.

In further embodiments, the generation of a new service or modification of a preexisting service may not affect other preexisting services. For example, a modification of a service, such as service 210 to include a new child tool comprising a new command and/or run algorithm may not affect other services within the SDF 108 that may include the same child tool.

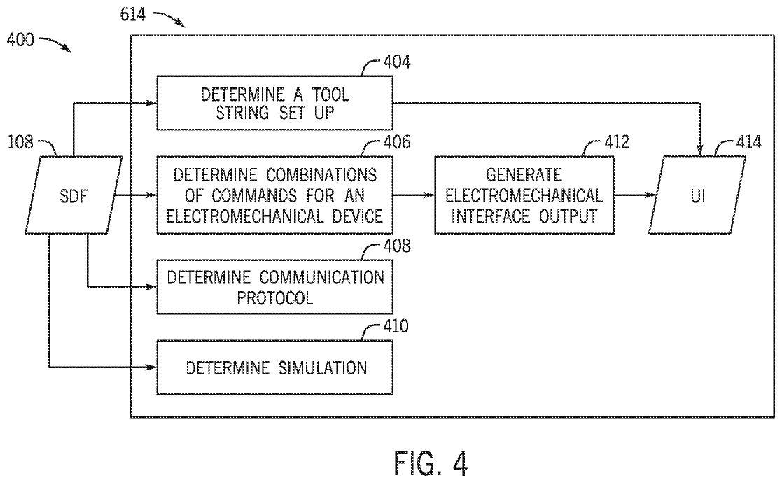

As described above, the SDF 108 may be used to generate a software application or user interface (UI) for controlling the tool system. To illustrate that, FIG. 4 shows an example of a process 400 for parsing the SDF 108 for software system 614 related information and generating a UI based on the SDF 108. As described above, the SDF 108 may include information relating to communications protocols between a software system 614 and downhole firmware of one or more tools, commands for the one or more tools, and/or the definitions (e.g., electronic definitions) of the one or more tools themselves. As such, the software system 614 may parse the SDF 108 to obtain relevant information for determining a desired service as indicated by block 404, determining combinations of commands for an electromechanical device comprising the one or more tools as indicated in block 406, determining communication protocols as indicated in block 408, and/or performing simulations as indicated in block 410. As discussed in detail below, the downhole firmware system may also parse the SDF 108 to obtain relevant downhole firmware system information in parallel (e.g., at the same time) to the software system 614.

In block 404 of the process 400, the software system 614 may parse the SDF 108 to determine a list of available services, such as service 210 illustrated in FIG. 3 and described above. For example, the software system 614 may parse via, a parser (e.g., python parser, C++ parser, C#parser, and other programming languages understood by one of ordinary skill in the art) to obtain the list of available services, wherein the software system 614 may then generate the UI adapted to display the available services to a user. Before and/or after the software system 614 receives information (e.g., user input) indicative of the desired service (e.g., desired tool combination, desired function), the software system 614 may perform a validation of the desired service based on tool information obtained from the SDF 108.

In some embodiments, parsing the SDF 108 may include translating the SDF 108 configuration, definition, and mapping sections into formats (e.g. binary or XML) that can be directly utilizable by designated downhole and surface targets (e.g., loadable to/linkable to/imported by). The targets may include, but are not limited to, electronic boards, firmware, or acquisition libraries.

In some embodiments, the software system 614 may parse the SDF 108 to obtain information or code related to data acquisition and/or communication protocols of tools, as shown in block 406. For example, the software system 614 may parse the SDF 108 to obtain information related to a master tool's telemetry frame size and/or the master tool's respective frame slots to channel mappings. In this way, the software system 614 may generate the correct communication protocols to receive data related to a respective tool or the one or more tools and send commands directed to the respective tool of the one or more tools. Similarly, the software system 614 may parse the SDF 108 to obtain information related to a child tool's frame size and/or the child tool's respective frame slots to channel mappings. In this way, the software system 614 may generate the correct communication protocols to receive data related to a respective child tool of the one or more tools. In some embodiments, the communication protocols may enable communication only between the parent tool and the software system 614, where then the child tool may communicate through the parent tool as a proxy.

At block 410, the software system 614 may parse the SDF 108 to obtain information to configure the data obtained in block 408. That is, the software system 614 may configure information related to a child tool's frame size and/or a child tool's respective frame slots to channel mappings. Similarly, the software system 614 may configure obtain information related to a tool's telemetry frame size and/or a tool's respective frame slots to channel mappings.

Returning to block 406, the software system 614 may further parse the SDF 108 to obtain and/or determine a combination of commands for one or more tools (e.g., electromechanical tools.) For example, as described above, a respective service may have one or more command functions that are associated with one or more desired commands for one or more tools. For instance, in a given service, a command may include a desired operating mode of a motor upon meeting a condition (e.g., a run time, a sensed temperature etc.) The software system 614 may parse, via, for example, a C++ parser, the SDF 108 to determine each command and the associated tool and/or combination of tools. Upon determination of the specific commands of a desired service (e.g., the service as determined in block 404) of the plurality of services, the software system 614 may generate an electromechanical interface output associated with the one or more commands within the SDF 108 as illustrated in block 412. In general, the electromechanical interface output may adjust a GUI to display information associated with the tool system 10, such as operational parameters and the like. In some embodiments, the software system 614 may generate an electromechanical interface output 414 based on the desired service, as determined by the user, in block 404. In other embodiments, the software system 614 may generate multiple electromechanical interface outputs 414 for the plurality of available services. In further embodiments, a single electromechanical; interface output may define multiple services including a plurality of commands. In any case, the software system 614 may generate the electromechanical interface output 414 based on the desired service and/or the plurality of services, wherein the interface includes parameters, commands, and or other features associated with components of a service.

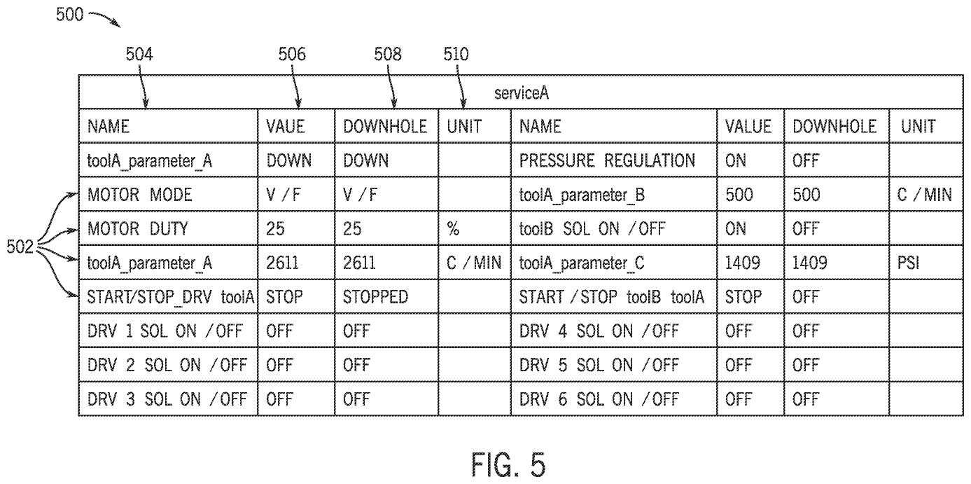

For example, FIG. 5 illustrates a user interface (“UI”) 500 that may be displayed to a user. As such, the electromechanical interface output 414 may cause a display to be displayed on any screen (e.g., display, user device, etc.) suitable for use by the user working on an oilfield operation and/or any other suitable location. The user interface 500 may be of a generic design for every service within the SDF 108 or may be designed dependent on a desired service chosen by the user. In any case, the user interface 500 may include a grid defining rows for various commands. It should be noted that the user interface 500 may include any suitable design, and is not limited to a grid design. In the present embodiment, one or more commands 502 may be displayed in the user interface 500 as comprising a name 504, a value and/or condition 506 (e.g., parameter condition and/or value), a downhole status condition 508 and a unit of measurement section 510, if necessary. However, is should be noted that other embodiments encompass more or less parameters for a respective command of the plurality of commands 502 in the user interface 500.

As illustrated, each command 502, obtained from the SDF 108 and pertaining to one or more tools, may include a given name 504, describing the command 502 to the user operating the user interface 500. For example, a command 502 may indicate an RPM of a motor of the one or more tools. Each command of the one or more commands 502 may further include the value and/or condition 506 input box (e.g., entry field, edit box, input region etc.) that may allow for user input. As such, the user may input desired parameters and/or operating conditions of the one or more tools. For example, the user may input a desired RPM of a motor as “2611,” indicating a desired RPM of 25 degrees/min (denoted in the unit section 510). The user interface 500 may also include a user input location capable of receiving user input and applying the inputted desired parameters and/or operating conditions to the one or more tools. For example, upon inputting a desired parameters and/or operating conditions, such as a motor rotation rate, the user may further input an indication to apply the desired parameters and/or operating conditions to the one or more tools. Each command of the plurality of commands 502 may further include the downhole status condition 508 which may include information pertaining to the current condition and/or value of a command of the one or more 502. For example, the downhole status condition 508 of a command may indicate a motor of a respective tool of the one or more tools is “off,” indicating the motor is currently in the off configuration. In any case, the user interface 500 displays information relating to a downhole service to the user, as well as input locations for desired operating conditions and/or parameters of tools used in a desired service. In this way, the user may easily modify and/or operate a tool system comprising the service including a combination of the one or more tools and/or the one or more commands 502.

In some embodiments, the user interface 500 may also include status indicators configured to alert, notify, and/or warn the user of a condition of a tool, a condition of a tool command, and/or a condition of a device of the tool. For example, the status indicators may include visual representations (e.g., a status bar, a power level, status color indicators) that may display relevant, timely information of the downhole tools.

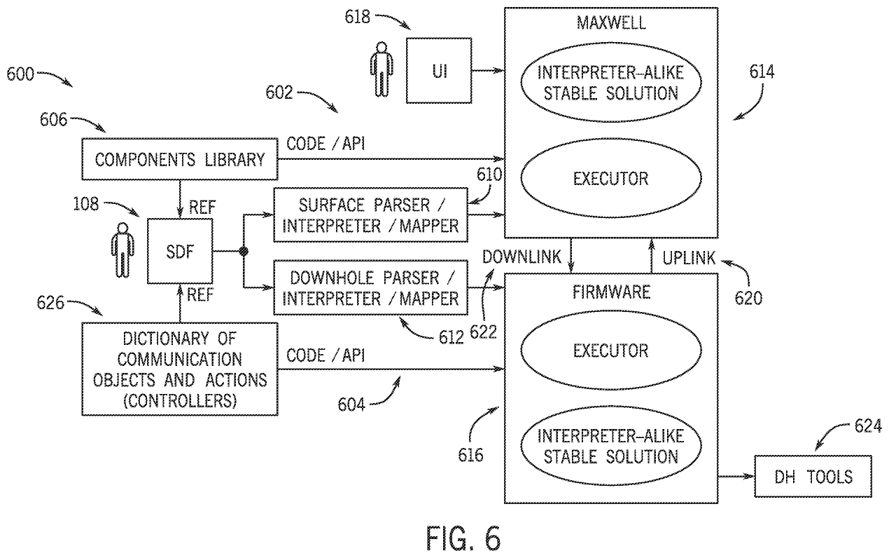

It is presently recognized that it may be advantageous to provide the SDF 108 to a software system 614 and a downhole firmware system 616, in parallel (e.g., at the same time), to reduce or eliminate the specification synchronization phase found in traditional systems. In this context, the specification synchronization phase relates to the collaboration needed for parallel development (e.g., coding) of both the software system and downhole firmware system to create and/or implement a service. For example, as shown in the process 600 of FIG. 6, in a conventional system, one or more coders may be utilized to generate code 602 (e.g., reference tool component information) that defines one or more tools of the plurality of tools present in the component library 606 to be read, used, or otherwise received by the software system 614. This generation of code 602 may include information such as commands, communication protocols and tool definitions (e.g., tool component definitions) needed in a desired service. In some embodiments, the code 602 may be utilized to be developed in a language (e.g., python, C++, etc.) capable of being used (e.g., interpreted) by the software system 614 itself. In a generally similar manner as described with respect to FIG. 2, the process 600 may be performed by one or more processors, such as the processor 30. In some embodiments, the software system 614 may be a cloud-based software system.

As discussed above, generation of code 604 may be generated separate from the generation of the code 602. This generation of code 604 (e.g., reference tool component information) may also include information such as the commands, communication protocols and tool definitions needed in a desired service. The generation of code 602 may further include information related to controllers of the downhole firmware system 616. In some embodiments, the code 604 may need to be developed in a language (e.g., python, C++, etc.) capable of being used (e.g., interpreted) by the downhole firmware system 616 itself. In some embodiments, the processor 30 may provide an application programming interface (API) to the downhole firmware system 616. Accordingly, the electromechanical interface output is generated based on the API. In any case, development of the code 602 and 604 may utilize increased collaboration and an extended amount of time.

As further illustrated in FIG. 6, the creation of SDF 108 may allow for desired service data, for both the downhole firmware system 616 and the software system 614, to be sourced from the same file. In some embodiments, the SDF 108 may be the same as SDF 108. For example, the SDF 108 may be generated by organizing services with respective commands, communication protocols, and one or more tool definitions (e.g., tool component definitions) as discussed above. Information related to the service components (e.g., commands, communication protocols, tool definitions, reference tool component information) may be obtained from a components library 606 and/or a communications objects and actions dictionary 626. The components library 606 and/or the dictionary 626 may obtain information (e.g., reference tool component information) from respective electronic data sheets (“EDS”) for a tool of the one or more tools 624, controller associated with the one or more tools 624, devices (e.g., PCBs, sensors, actuators) associated with the one or more tools 624, etc. The components library 606 and the dictionary 626 may include information related to the service components (e.g., commands, communication protocols, tool definitions, reference tool component information) in a human readable form (e.g., human speech language, natural language text). In some embodiments, the SDF 108 may be coded, generated, or otherwise created in a single language (e.g., single code language (e.g., textual)) where then the SDF 108 may be further translated into formats (e.g. language formats, code languages, machine readable formats) able to be utilized by the software system 614 and the downhole firmware system 616. In some embodiments, the software system 614 may be cloud-based.

For example, at block 610, a portion (e.g., first portion, first human readable form portion) of information and/or data within the SDF 108 may be validated using a validator (e.g., by a standalone application) before the portion is received by a parser (e.g., C++ parser, downhole parser, parser program, parser component) to obtain relevant service information (e.g., commands, communication protocols, tool definitions, etc.) utilized by the software system 614. The parser may analyze the portion of the information and/or data within the SDF 108 to check for errors (e.g., syntax errors) and perform other functions to prepare the portion for further processing. Further, an interpreter may read and translate the portion of the information and/or data to translate from a human readable format into a processed format (e.g., machine readable format). After, the processed format of the portion of information and/or data within the SDF 108 utilized may be mapped (e.g., converted, transformed, translated) into a new data format (e.g., language) utilized by the software system 614. In this way, the portion of the information and/or data within the SDF 108 utilized by the software system 614 may be validated and converted into a suitable format (e.g., parsed service definition file output) utilized by the software system 614.

In preferred embodiments, parallel to the SDF 108 processing performed in block 610, block 612 performs similar processing of a portion (e.g., second portion, second human readable portion) of information and/or data utilized by the downhole firmware system 616 for a desired service. As will be appreciated, the second portion of information and/or data may be sourced from the same SDF 108 used in block 610. As such, the same SDF 108 may be used for both supplying the software system 614 and the downhole firmware system 616 with information and/or data utilized to operate/implement a desired service. That is, a second portion of information and/or data within the SDF 108 may be validated using a second validator (e.g., by a standalone application) before the second portion is received by a second parser (e.g., python parser, downhole parser, parser program, parser component) to obtain relevant service information (e.g., commands, communication protocols, tool definitions, etc.) utilized by the downhole firmware system 616. The second parser may analyze the second portion of the information and/or data of the SDF 108 to check for errors (e.g., syntax errors) and perform other functions to prepare the second portion for further processing.

Further, a second interpreter may read and/or translate the second portion of information and/or data to translate from a human readable format into a processed format (e.g., machine readable format). After, the processed format of the second portion of information and/or data within the SDF 108 utilized by the downhole firmware system 616 may be mapped (e.g., converted, transformed, translated) into a new data format (e.g., parsed service definition file output) utilized by the downhole firmware system 616. In this way, the second portion of the information and/or data within the SDF 108 utilized by the downhole firmware system 616 may be validated and converted into a suitable format utilize by the downhole firmware system 616 parallel to the processing of the portion of information and/or data utilized by the software system 614.

After processing of the second portion of information and/or data, the downhole firmware system 616 may receive the processed second portion in a suitable format (e.g., machine readable format). The downhole firmware system 616 may further include a fourth interpreter, that may recognize the second portion of information and/or data received from the SDF 108. In preferred embodiment's, the fourth interpreter is rarely changed (e.g., updated). Upon receiving the second portion of information and/or data, the downhole firmware system 616 may obtain a machine-readable format for the information related to the service components obtained from the dictionary 626. The downhole firmware system 616 may further include an executor adapted to perform implementation of commands and/or communication protocols present in the second portion of information and/or data within the SDF 108.

Returning to block 610, after processing of the first portion of information and/or data, the software system may receive the processed first portion in a suitable format (e.g., machine readable format). The software system 614 may further include a third interpreter, that may recognize the first portion of information and/or data received from the SDF 108. Upon receiving the first portion of information and/or data, the software system 614 may obtain a machine-readable format for the information related to the service components obtained from the components library 606. The software system 614 may further include an executor that may perform implementation of commands and/or communication protocols present in the first portion of information and/or data within the SDF 108. In preferred embodiment's, the third interpreter is rarely changed (e.g., updated).

In some embodiments, the software system 614 may further receive information from a user interface 618, indicative of tool parameters and/or a desired service. For example, user interface 618 may be the same as user interface 500 discussed above in regards to FIGS. 4 and 5, where a user may generate and/or update the user interface 500 to reflect a desired service and desired command parameters of the one or more tools 624 included in a tool combination of a desired service. In any case, the software system 614 may include information and/or data from the SDF 108 utilized for control and/or communication for a desired service. For example, the software system 614 may perform various communications (e.g., uplinks, downlinks) associated with the first portion of information and/or data form the SDF 108.

For example, the software system 614 may uplink data 620 (e.g., sensor data, actuator data, uplink telemetry data) from the downhole firmware system 616.

Communication protocols that may enable the software system 614 query and receive uplink data 620 may be found in the first portion of information and/or data received by the software system 614 from the SDF 108. In some embodiments, uplink data 620 may be communicated through a Controlled Area Network (e.g., CAN, CAN variation). In some embodiments, uplink data 620 may include communication status indicators, tool operation status, sensor information, identification information, and the like.

Further, the software system 614 may downlink 622 commands (e.g., commands for the one or more tools 624 of a desired service) from the software system 614 to the downhole firmware system 616 to control or otherwise operate the one or more tools 624. In some embodiments, the software system 614 may downlink (e.g., send, communicate) both low-level commands and high-level commands received from information and/or data of the SDF 108. Low-level commands in this context may include commands relating to events, conditions, and actions associated with the one or more tools 624. For example, a low-level command may be related to manipulation of tools, for instance, actuation of a tool part (e.g., motor) of the one or more tools 624. Further, in some embodiments, low-level commands may be implemented into the SDF 108 from the components library 606 as discussed above. In other embodiments, low-level commands not preexisting in the components library 606 may be generated and supplied to the software system 614 separate from the SDF 108, via code 602. After generation and/or implementation of a new low-level command, the software system 614 may save or otherwise store the low-level command to the components library 606 for further use in a new service. In some embodiments, low-level commands and respective command information may be displayed on the user interface 618 to receive desired parameter input by a user. As such, certain low-level commands downlinked to the downhole firmware system 616 via downlink 622 may include data and/or parameter inputs from a user interface 618, in addition to or in place of the data from the SDF 108.

High-level commands in this context may be commands that are generally more complicated than a low-level command. For example, a high-level command may coordinate the synchronized operation of multiple low-level commands that are mapped to state machine inputs of the downhole firmware system 616 to achieve a desire high-level function. For instance, a high-level command to “set tool mode” may include multiple commands mapped to downhole firmware system 616 machine inputs (e.g., setting motor parameters, setting motor algorithms, setting motor type, etc.) for the one or more tools 624 to perform one or more high-level functions. In this way, high-level commands may enable user-friendly operation and/or directing of multiple low-level commands to perform complex functions.

In some embodiments, communication protocols to query and receive uplink data 620 may be found in the first portion of information and/or data received by the software system 614 from the SDF 108.

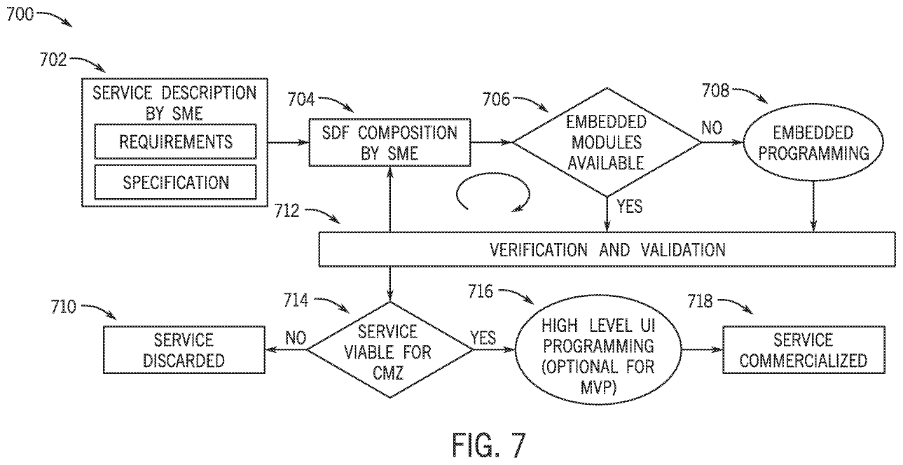

FIG. 7 illustrates a flow diagram 700 representing the creation of one or more services by a user (e.g., subject matter expert), generating a SDF based on the one or more service, and commercialization of the one or more services created. At block 702, the user may create a new service including service components comprising a composition and configuration of one or more tools (e.g., electromechanical tools of a tools string,) commands, and respective communication protocols, which may be also known collectively as new reference tool component information. A new service may be created due to a newly desired configuration of a tool string including the one or more tools, desired parameters of the one or more tools, requirements of an oilfield operation, or any other suitable reason.

After the service is created or defined or otherwise conceived by the user, the user may then generate the SDF at block 704. In some embodiments, the SDF may be the same SDF 108 described above. As such, the SDF may be generated in a similar manner to the SDF 108 as described above in FIGS. 2 and 6. That is, the generation of the SDF may include organizing services comprising tool definitions (e.g., tool component definitions) for the one or more tools, commands (e.g., commands data), communication protocols (e.g., communication protocols data), and any other service definitions. In some embodiments, the SDF may be created through existing service components (e.g., modules, reference tool components) at block 706, comprising preexisting tool definitions of the one or more tools, preexisting commands (e.g., high-level commands, low-level commands), and/or preexisting communication protocols (e.g., uplink, downlink,) stored within storage units (e.g., component library, component dictionary). In some embodiments, preexisting service components (e.g., tool definitions for the one or more tools, commands, communication protocols) may be obtained from previous services. In any case, the user may access preexisting service components to create the new service, thereby expediting the application creating process for a desired service.

In embodiments where service components are not preexisting (e.g., not available in via block 706), the user may code or otherwise create new service components of a new service for further validation and verification in block 712. For example, in an embodiment where the user desires to create a new service comprising new components (e.g., a new tool(s), new command(s), and/or new communication protocol(s),) a new service component may be coded or otherwise created. Upon creation of the new service component for the new service, the new component may be made available (e.g., a new SDF may be created and/or the new service component may be added to an existing SDF) via block 706 for future desired service generation.

Creating a new service component may comprise steps of creating communication and controller features as virtual objects; consuming said objects by the software system; loading said virtual objects into the pre-existing physical downhole tools to reuse existing processing power and to bypass hardware driver layer in the absence of new electronics for new tools; thereby creating an emulator and a hybrid tool model for a provisioned new service. In this way, embodiments of the present disclosure may enable accelerated tool and/or service prototyping decreasing the time to market implementation

In any case, to implement a service component (e.g., preexisting service component, new service component) into the organizational structure of the SDF in block 704, the software system may verify and validate the service components in block 712. Upon validation and verification of the service components at block 702, the SDF may be generate.

In some embodiments, after verification and validation of the components of a desired service generated in blocks 702, 704, 706, and/or 708, there may be a determination on whether the desired service created is viable for commercialization. That is, a computer software or a human user may decide whether a service is economically and/or mechanically desirable. Upon determination that the service is not viable for commercialization, the service may be discarded. For example, in block 710, the created service may be deleted from the SDF or otherwise discarded as a viable service for commercialization.

In embodiments where the generated service is desirable (e.g., viable) for commercialization (e.g., “CMZ”) via a determination in block 714, a user interface may be generated in block 716. For example, the user interface in block 716 may be similar to the user interface 500 discussed in FIG. 5. That is the user interface generated by the software system may include low-level commands related to the desired service generated and/or selected. In further embodiments, the user interface generated in block 716 may include high-level commands, similar to the high-level commands discussed above. The user interface generated in 716 may be a high-level user interface, including high-level features (e.g., features to increase user friendliness). However, it should be noted, the user interface does not require high-level features for the minimal viable product (e.g., “MVP”).

In some embodiments, the user interface generated using the SDF may be further developed through optional coding to improve interface design and user experience. For example, the user interface ultimately created by or associated with the SDF may be further coded (e.g., hand coded) to improve a design of the user interface, specific input needs, and/or any other desirable user interface parameter desirable. After the user interface is created in block 716, the service may be commercialized in block 718.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving an indication of an electromechanical tool system comprising two or more tool components, wherein each tool component is configured to perform a respective service;
retrieving electronic information for the two or more tool components based on the indication;
retrieving firmware information for the two or more tool components based on the indication;
generating a service definition file based on the electronic information and the firmware information, wherein the service definition file indicates a plurality of services capable of being performed by the two or more tool components; and
outputting the service definition file to control operation of the electromechanical tool system.

2. The method of claim 1, wherein generating the service definition file comprises:
identifying a combined service to be performed by a subset of the two or more tool components operating in a concerted manner; and
generating the service definition file that includes the combined service.

3. The method of claim 1, wherein outputting the service definition file comprises providing the service definition file to a software system and a downhole firmware system in parallel.

4. The method of claim 1, wherein the service definition file that indicates the plurality of services capable of being performed by the two or more tool components comprises:
a first service hierarchical organization indicating a first subset of electronic information and firmware information; and
a second service hierarchical organization indicating a second subset of electronic information and firmware information.

5. The method of claim 1, wherein the service definition file includes firmware mappings and electronic mappings for the electromechanical tool system.

6. The method of claim 1, wherein the two or more tool components comprise a downhole shifting component, a downhole milling component, a downhole cutting component, a downhole tractor component, a downhole collecting component, a downhole power component, a downhole drive component, a downhole telemetry component, or a combination thereof.

7. A method, comprising:
receiving an indication of an electromechanical tool system comprising two or more tool components, wherein each tool component is configured to perform a respective function;
retrieving reference tool component information corresponding to the two or more tool components based on the indication;
generating a service definition file based on the reference tool component information, wherein the service definition file indicates a plurality of services capable of being performed by the two or more tool components;
providing the service definition file to a software system and a downhole firmware system in parallel;
receiving an electromechanical interface output as an output from the software system; and
controlling operation of the electromechanical tool system based on the electromechanical interface output.

8. The method of claim 7, wherein providing the service definition file to the software system comprises:
providing the service definition file to a surface software parser to obtain a parsed service definition file output, wherein the parsed service definition file output comprises a data format configured to be utilizable by the software system; and
providing the parsed service definition file output to the software system.

9. The method of claim 7, wherein providing the service definition file to the downhole firmware system comprises:
providing the service definition file to a downhole software parser to obtain a parsed service definition file output, wherein the parsed service definition output comprises a data format configured to be utilizable by the downhole firmware system; and
providing the parsed service definition file output to the downhole firmware system.

10. The method of claim 7, comprising providing an application programming interface (API) to the downhole firmware system, and wherein the electromechanical interface output is generated based on the API.

11. The method of claim 7, wherein the service definition file at least partially comprises data associated with a downlink between the software system and the downhole firmware system, wherein the downlink comprises a plurality of commands and command mappings.

12. The method of claim 11, wherein the plurality of commands comprises:
low-level commands, wherein the low-level commands comprise conditions for the one or more tool components, events for the one or more tool components, actions for one or more tool components; or a combination thereof; and
high-level commands, wherein the high-level commands comprise a combination of low-level command configured to perform a high-level function.

13. The method of claim 8, wherein the service definition file at least partially comprises data associated with an uplink telemetry between the software systems and the downhole firmware system.

14. A non-transitory computer-readable medium comprising computer-executable instructions that, when executed, are configured to cause a processor to:
receive an indication of an electromechanical tool system comprising two or more tool components, wherein each tool component is configured to perform a respective function and wherein at least one tool component of the two or more tool components comprises one or more devices;
obtain a reference tool component information corresponding to the two or more tool components based on the indication;
generate a service definition file based on the reference tool component information, wherein the service definition file indicates a plurality of services capable of being performed by the two or more tool components;
provide the service definition file to a software system and a downhole firmware system in parallel;
receive an electromechanical interface output as an output from the software system and the downhole firmware system; and
control operation of the electromechanical tool system based on the electromechanical interface output.

15. The non-transitory computer-readable medium comprising computer-executable instructions of claim 14, wherein the electromechanical interface output comprises a communications mapping for the two or more tool components of the electromechanical tool system.

16. The non-transitory computer-readable medium comprising computer-executable instructions of claim 14, wherein each service of the plurality of services comprises a plurality of modules, wherein each the plurality of modules comprises at least one of communication protocols data, command data, and tool component definitions.

17. The non-transitory computer-readable medium of claim 16, wherein each service of the plurality of services includes a hierarchical structure based on the plurality of modules.

18. The non-transitory computer-readable medium of claim 16, comprising computer-executable instructions that, when executed, are configured to cause a processor to:
generate a user interface based on the service definition file, wherein the user interface is configured to receive input associated with the command data, the communication protocols data, or the tool component definitions.

19. The non-transitory computer-readable medium of claim 16, comprising computer-executable instructions that, when executed, are configured to cause a processor to:
determine an operational relationship between a first tool component of the two or more tool components and a second tool component of the two or more tool components, wherein the operational relationship indicates that the first tool component is a master tool of the second tool component; and
control operation of the electromechanical tool system based on the operational relationship.

20. The non-transitory computer-readable medium comprising computer-executable instructions of claim 14, wherein the software system is cloud-based.
